(19) United States
(12) Patent Application Publication
(10) Pub. No.: US 2010/0147452 A1
(43) Pub. Date: Jun. 17, 2010

(54) PHOTO PORTRAIT MEDIA FOR DIGITAL PRINTERS

(75) Inventors: John M. Viavattine, Rochester, NY (US); Christian Redder, Rochester, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/337,484

(22) Filed: Dec. 17, 2008

(51) Int. Cl. B32B 3/10; B41M 5/00; B32B 38/10

(52) U.S. Cl. 156/247; 428/195.1; 428/43

(57) ABSTRACT

A photo quality multi-layered sheet suitable for digital printing includes a first sheet patterned in pre-determined dimensions for rendering a photographic image thereupon and a second sheet married to said first sheet by an adhesive, wherein said adhesive only remains upon said second sheet when said second sheet is removed from said first sheet. The adhesive also allows for the first sheet to be repositioned on the second sheet. The first sheet lays flat once removed from the second sheet, and the pre-determined dimensions are of a conventional size, which are created by die-cutting or die-perforating in order to maintain clean edges when the pre-determined dimensioned areas are separated from one another.

### BACKGROUND

The present embodiments relate generally to a layered media product for printing in an electrophotographic or xerographic device in which the top layer of the layered media product may be removed easily without transferring adhesive from a bottom layer to the removed top layer. The top layer is die-cut into pre-determined dimensions that may be disassembled by the recipient without the need for post processing image cutting equipment.

In commercial processing, images can be provided to an operator for developing in several ways. If the images are on film, the film is removed automatically or by an operator handling the film in a light proof bag, which then feeds the film into the processing machine. If the images are digital, and located on a storage media, such as a flash memory card, the images are downloaded or emailed to a computer, which then provides the images to the processing machinery. The processing machinery is generally run on a continuous basis with films spliced together in a continuous line. All the processing steps are carried out within a single processing machine with automatically controlled time, temperature and solution replenishment rate. The prints emerge washed and dried, and are ready to be cut by hand or by post-processing equipment.

Printers currently producing photographs are limited to onsite cut-size papers, and must have post-processing equipment to trim the photograph paper into desired dimensions. Often times, retail space is limited, and post-processing equipment is difficult or impossible to place within the retail space.

In order to overcome these problems, the foregoing embodiments are provided. The purpose of these embodiments is to enable printing of standard consumer size photographs, which are traditionally developed through a silver halide process from an electronic file with the use of a toner-based laser printer, without the need for post-processing cutting and trimming equipment.

The foregoing generally describes photo processing in which printing sheets are cut by post-processing equipment into desired dimensions.

### SUMMARY

According to embodiments illustrated herein, there is provided a photo processing invention and method for providing various printing sheets that may be sized according to desired photo dimensions without requiring post-processing equipment for trimming the printing sheets to a desired photo size.

More particularly, a multi-layered sheet suitable for digital printing comprises a first sheet patterned in pre-determined dimensions for rendering a photographic image thereupon, and a second sheet married to the first sheet by an adhesive. The adhesive only remains upon the second sheet when the second sheet is removed from the first sheet.

Also, a method for providing printed digital photos of conventional dimensions without post-processing photo trimming equipment. The method comprises patterning a first sheet in pre-determined dimensions for rendering a photographic image thereupon, and marrying the first sheet to a second sheet with an adhesive. The adhesive only remains upon the second sheet when the second sheet and the first sheet are separated.

A multi-layered sheet suitable for digital printing comprises a first sheet patterned in pre-determined dimensions for rendering a photographic image thereupon, and a second sheet married to the first sheet by an acrylic based adhesive. The adhesive allows for repositioning of the first sheet on the second sheet.

### BRIEF DESCRIPTION OF THE DRAWINGS

For a better understanding of the present embodiments, reference may be had to the accompanying figures.

FIG. 1 is a top view of a media product for printing in accordance with the present embodiments.

FIG. 2 is a view of another media product in accordance with the present embodiments.

FIG. 3 is a view of another media product in accordance with the present embodiments.

FIG. 4 is a view of another media product in accordance with the present embodiments.

FIG. 5 is a view of another media product in accordance with the present embodiments.

FIG. 6 is a view of another media product in accordance with the present embodiments.

FIGS. 7a through 7c illustrate the separation of a multi-layer sheet into single photographs in accordance with the present embodiments.

FIGS. 8a and 8b illustrate the production of various combinations of images in accordance with the present embodiments.

### DETAILED DESCRIPTION

In the following description, it is understood that other embodiments may be utilized, and structural and operational changes may be made without departure from the scope of the present embodiments disclosed herein.

The present embodiments relate to a photo processing product and method for providing various printing sheets that may be sized according to desired photo dimensions without requiring post-processing equipment for trimming the printing sheets to a desired photo size.

In order to keep photograph edges free of ties and other debris, the photograph sizes are clean die-cut, for example by a die-cut perforation or a die-cut score, into a digitally optimized 8 mil thick Xerox® Supreme Gloss sheet, which is designed to have a high gloss cast coated surface. For example, the coating formulation for a 93 GSM 8 mil Xerox® Supreme Gloss sheet with high gloss finish is smoothness optimized for image quality and toner anchorage. This surface possesses characteristics that are the closest to commercial grade photographic paper, and because the surface has enhanced smoothness and coating formulation, it promotes optimum laser image quality and toner anchorage.

Although other combinations will be evident to those having ordinary skill in the art, in the preferred embodiment, the Xerox® Supreme Gloss sheet is backed with a 35# Densified Kraft® liner, which is used as a carrier for an adhesive that is used to hold the lamination together. In other words, the adhesive adheres the Xerox® Supreme Gloss sheet to the 35# Densified Kraft® liner. The Densified Kraft® liner allows for the least expensive method of construction, and it has the lowest propensity for static build-up in a sheet feed xerographic printer. The Densified Kraft® liner also has a hard surface that will not be damaged by the use of dies.

The Xerox® Supreme Gloss sheet and the Densified Kraft® liner combination (“the product”) is received by an end user, who then places the product into a laser printer paper feed drawer of the xerographic printer (or similar printer). The printer is activated with appropriate image files, and the images are transferred onto the product. The product is then delivered to an appropriate output module, such as a Top Tray, Stacker, or the like. The end user, who may be an operator of the printer or a customer of the photograph processing service, removes the printed sheet and peels away die-cut photos from the backing liner. The removed die-cut photos are free of adhesive and have clean edges, meaning free of ties and other debris.

Photographs are rendered in several standard conventional sizes. For example, common standard conventional sizes include: 8 inches×10 inches (commonly referred to as an “8×10” or “eight by ten”), 5 inches×7 inches (commonly referred to as a “5×7” or “five by seven”); 4 inches×6 inches (commonly referred to as a “4×6” or “four by six”); 3 inches×5 inches (commonly referred to as a “3×5” or “three by five”); and wallet size. “Four by six” and “three by five” are the more common sizes among consumer print sizes.

Standard conventional wallet sized photographs may have different dimensions depending on the size of the photo sheets from which the wallet photographs are cut. For instance, if the photo sheet has the dimensions 5×7 inches or 11×14 inches, then the wallets are sized to the dimensions 2½×3½ inches, in order to evenly divide the photo sheet. Likewise, if the photo sheet is 8×10 inches in dimension, then in order to evenly divide the photo sheet into the smaller wallet-sized prints, the dimensions of the wallet-sized prints will be 2⅓×3⅓ inches. Wallet sized photos may also be 2×3 inches.

Other photographs are produced in dimensions consistent with international paper sizes, such as A2 (60 cm×42 cm), A3 (42 cm×30 cm), and A4 (30 cm×21 cm).

In the preferred embodiment, an 11 inch×17 inch Xerox® Supreme Gloss sheet is used with a 35# Densified Kraft® liner of similar dimensions. The 11×17 sheet size accommodates multiples of standard photograph sizes, which may be all of one dimension, or a mix of various dimensions. For example, an 11×17 sheet can accommodate the following conventional sizes: two 8×10 photographs; one 8×10, one 5×7, and four 2½×3½ wallet photographs; six 4×6 photographs; four 5×7 photographs, or any other combination that will fit within the confines of the 11×17 sheet.

Throughout the description of the figures, terms such as “top x-axis” and “bottom x-axis” are used to help describe the placement of various pre-determined dimensioned patterns as shown in the particular figure being described. Likewise, terms such as “left y-axis” and “right y-axis” are used to help describe the placement of various pre-determined dimensioned patterns as shown in the particular figure being described. These terms are relative to the figure, and it will be commonly understood in the art that the placement of the pre-determined dimensioned patterns may result in several variations that maintain the spirit of this product. Furthermore, in order to help clarify the actual positioning of the pre-determined dimensioned patterns, the first listed dimension is equivalent to the x-axis measurement, and the second listed dimension is equivalent to the y-axis measurement. Therefore, as an example, if the standard size being used is an 8×10, this may be re-written as “10×8” in order to illustrate that the pre-determined dimensioned pattern is positioned in such a way that the “10” represents the number of inches along the x-axis, and the “8” represents the number of inches along the y-axis.

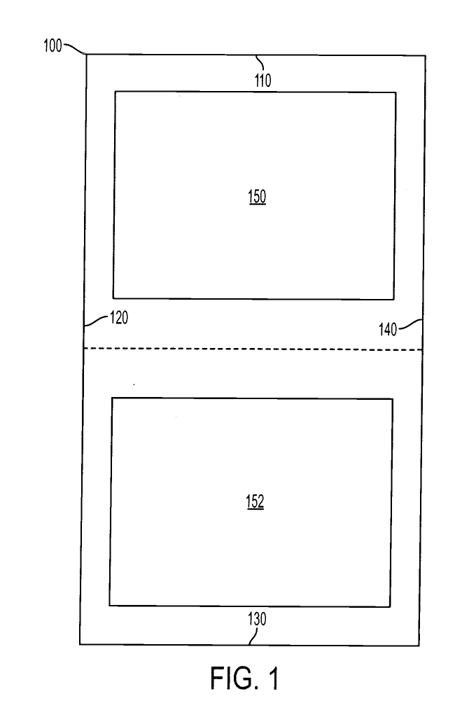

As illustrated in FIG. 1, in one embodiment of the presently described embodiments, an 11×17 sheet (100) having four edge boundaries—top x-axis (110), left y-axis (120), bottom x-axis (130), and right y-axis (140)—may be divided into pre-determined dimensions; a first pre-determined dimension of 10×8 (150) is positioned at 7/16 of an inch from the top x-axis edge boundary (110) and centered between the left y-axis (120) and the right y-axis (140), which leaves a ½ inch margin between the first pre-determined dimension of 10×8 (150) and either y-axis (120 and 140). The placement of this pre-determined dimension of 10×8 occupies roughly the top half of the 11×17 sheet (100), leaving the bottom half of the 11×17 sheet (100) available for a second pre-determined dimension of 10×8 (152), which is positioned in a similar manner as the first pre-determined dimension of 10×8 (150), except that the second pre-determined dimension of 10×8 (152) is positioned at 7/16 of an inch from the bottom x-axis edge boundary (130) and centered between the left y-axis (120) and the right y-axis (140), which leaves a ½ inch margin between the second pre-determined dimension of 10×8 (150) and either y-axis (120 and 140).

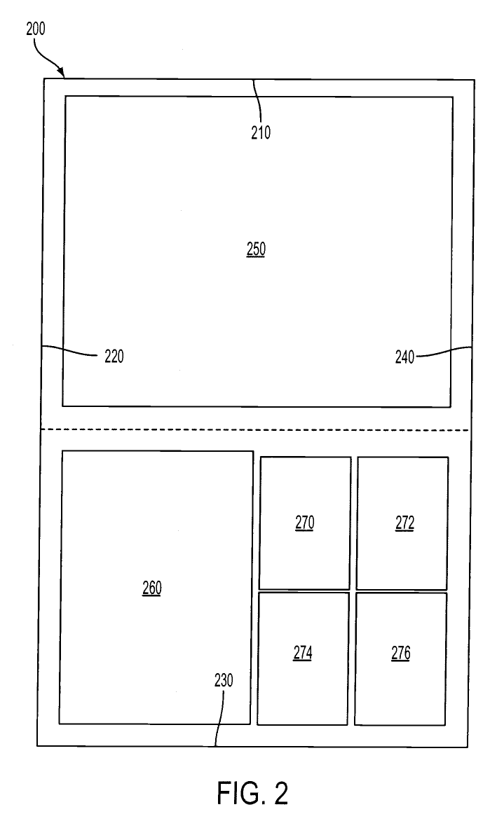

As illustrated in FIG. 2, in another embodiment of the presently described embodiments, an 11×17 sheet (200) having four edge boundaries—top x-axis (210), left y-axis (220), bottom x-axis (230), and right y-axis (240)—may be divided into pre-determined dimensions; a first pre-determined dimension of 10×8 (250) is positioned at 7/16 of an inch from the top x-axis edge boundary (210) and centered between the left y-axis (220) and the right y-axis (240), which leaves a ½ inch margin between the first pre-determined dimension of 10×8 (250) and either y-axis (220 and 240). The placement of this pre-determined dimension of 10×8 occupies roughly the top half of the 11×17 sheet (200), leaving the bottom half of the 11×17 sheet (100) available for a combination of other pre-determined dimensions.

FIG. 2 further illustrates a pre-determined dimension of 5×7 (260) and four wallet-sized patterns of pre-determined dimensions of 2⅜ inches×3⅜ inches (270, 272, 274, and 276) positioned in the bottom half of the 11×17 sheet (200). The pre-determined dimension of 5×7 (260) is positioned at ½ of an inch from the left y-axis (220) and ½ inch from the bottom x-axis (230). Two of the four wallet-sized patterns of pre-determined dimensions of 2⅜ inches×3⅜ inches (272 and 276) are positioned ½ of an inch from the right y-axis (240), with wallet-sized pattern (272) being positioned ⅛ of an inch above wallet-sized pattern (276). As is illustrated in FIG. 2, two of the four wallet-sized patterns of pre-determined dimensions of 2⅜ inches×3⅜ inches (274 and 276) are positioned ½ of an inch from the bottom x-axis (230), with wallet-sized pattern (274) being positioned ⅛ of an inch to the left of wallet-sized pattern (276). One of the four wallet-sized patterns of pre-determined dimensions of 2⅜ inches×3⅜ inches (270) is positioned ⅛ of an inch above wallet-sized pattern (274) and is positioned ⅛ of an inch to the left of wallet-sized pattern (272). Hence, wallet-sized patterns (270 and 274) are positioned ⅛ of an inch to the right of the pre-determined dimension of 5×7 (260). This particular embodiment will also accommodate wallet-sized patterns of 2½ inches×3½ inches, which will reduce the margin spacings between the wallet-sized patterns and the edge boundaries of the 11×17 sheet.

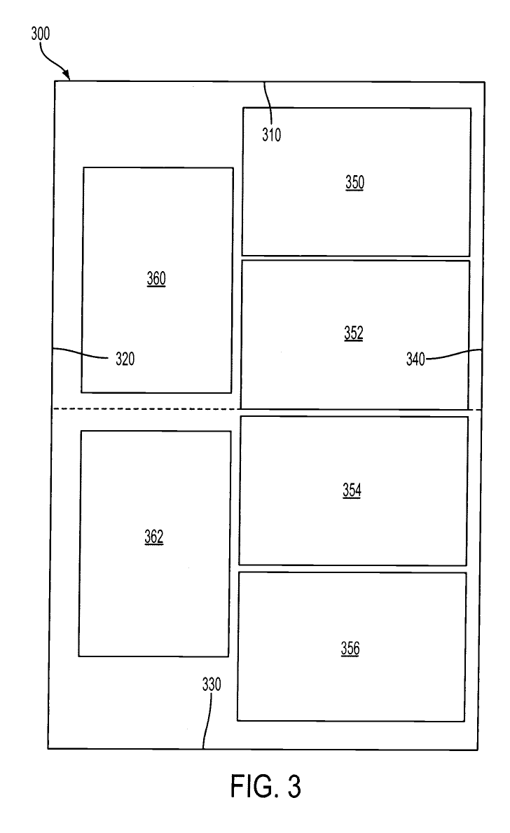

As illustrated in FIG. 3, in another embodiment of the presently described embodiments, an 11×17 sheet (300) having four edge boundaries—top x-axis (310), left y-axis (320), bottom x-axis (330), and right y-axis (340)—may be divided into four pre-determined dimensions of 6×4 (350, 352, 354, and 356) and two pre-determined dimensions of 4×6 (360 and 362). The first pre-determined dimension of 4×6 (360) is positioned two inches from the top x-axis (310) and ⅜ inch from the left y-axis (320). The second pre-determined dimension of 4×6 (362) is positioned two inches from the bottom x-axis (330) and ⅜ of an inch from the left y-axis (320). The first pre-determined dimension of 6×4 (350) is positioned 5/16 of an inch from the top x-axis (310) and ⅜ of an inch from the right y-axis (340). The second pre-determined dimension of 6×4 (352) is positioned ⅛ of an inch below the first pre-determined dimension of 6×4 (350) and ⅜ of an inch from the right y-axis (340). The third pre-determined dimension of 6×4 (354) is positioned ⅛ of an inch below the second pre-determined dimension of 6×4 (352) and ⅛ of an inch above the fourth pre-determined dimension of 6×4 (356). The third pre-determined dimension of 6×4 (354) is also positioned ⅜ of an inch from the right y-axis (340). The fourth pre-determined dimension of 6×4 (356) is positioned 5/16 of an inch from the bottom x-axis (330) and ⅜ of an inch from the right y-axis (340).

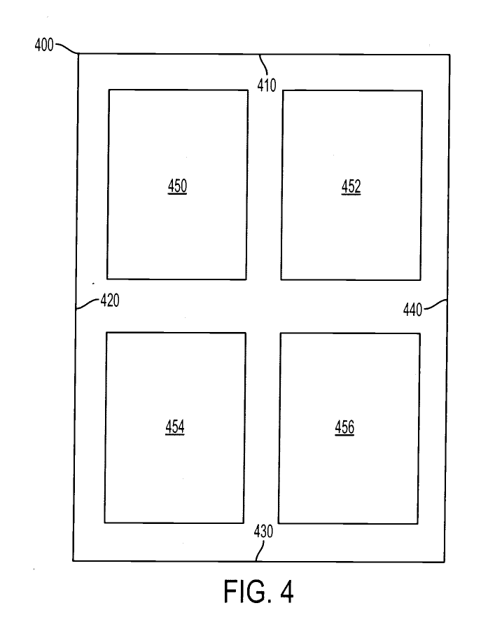

As illustrated in FIG. 4, in yet another embodiment of the presently described embodiments, an 11×17 sheet (400) having four edge boundaries—top x-axis (410), left y-axis (420), bottom x-axis (430), and right y-axis (440)—may be divided into four pre-determined dimensions of 5×7 (450, 452, 454, and 456). The first pre-determined dimension of 5×7 (450) is positioned one inch from the top x-axis (410) and ⅜ inch from the left y-axis (420). The second pre-determined dimension of 5×7 (452) is positioned one inch from the top x-axis (410) and ⅜ inch from the right y-axis (440), the positioning thereof creates a ¼ of an inch margin between the first pre-determined dimension of 5×7 (450) and the second pre-determined dimension of 5×7 (452). The third pre-determined dimension of 5×7 (454) is positioned one inch from the bottom x-axis (430) and ⅜ inch from the left y-axis (420). The fourth pre-determined dimension of 5×7 (456) is positioned one inch from the bottom x-axis (430) and ⅜ inch from the right y-axis (440), the positioning thereof creates a ¼ of an inch margin between the third pre-determined dimension of 5×7 (454) and the fourth pre-determined dimension of 5×7 (456). This positioning scheme also creates a one inch margin between the bottom boundaries of the first and second pre-determined dimensions of 5×7 (450 and 452) and the top boundaries of the third and fourth pre-determined dimensions of 5×7 (454 and 456).

Other embodiments may include a sheet as described above, but with different dimensions, such as 11 inches×14 inches.

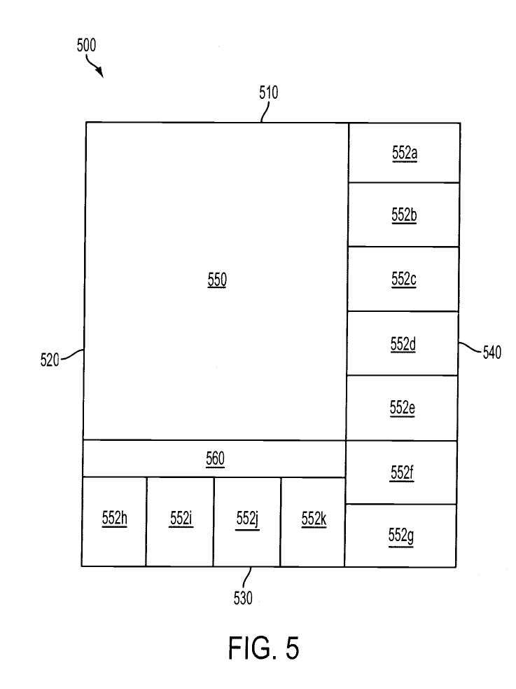

As illustrated in FIG. 5, in one embodiment of the present embodiments, an 11×14 sheet (500) having four edge boundaries—top x-axis (510), left y-axis (520), bottom x-axis (530), and right y-axis (540)—may be divided into pre-determined dimensions; one pre-determined dimension of 8×10 (550) sharing portions of two edge boundaries (510 and 520) with the 11×14 sheet (500); one edge boundary along the top x-axis (510) and another edge boundary along the left y-axis (520). The remaining area of the 11×14 (500) sheet may be divided into pre-determined dimensions of 3×2 (552a through 552g) and 2×3 (552h through 552k) for wallet-sized prints. A wallet of dimensions 2×3 (552h) shares the remaining portion of the edge boundary along the left y-axis (520). Also, the wallets of dimensions 2×3 (552h through 552k) share a portion of the edge boundary along the bottom x-axis (530). The wallets of dimensions 3×2 (552a through 552g) share the other boundary along the right y-axis (540) where a wallet of dimensions 3×2 (552a) shares the remaining portion of the top x-axis (510) boundary and a wallet of dimensions 3×2 (552g) shares the remaining portion of the bottom x-axis (530) boundary. An empty section (560) remains, and may be used for photographs of very small dimensions, in one embodiment, five photographs of dimensions 1 inch by 1½ inches will fit within the dimensions of the section (560) leaving a small portion unused. Also, in another embodiment, this section (560) may contain information, for example, the photo processor's contact information, multi-layer sheet information, or an advertisement. This empty section (560) may also be left blank.

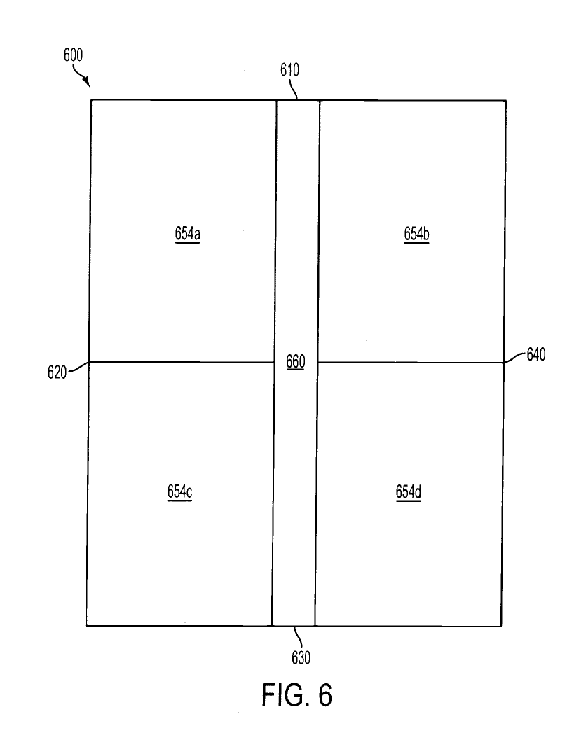

Referring to FIG. 6, in another embodiment, an 11×14 sheet (600) having four edge boundaries—top x-axis (610), left y-axis (620), bottom x-axis (630), and right y-axis (640)—may be divided into four pre-determined dimensions of 5×7 (654a through 654d). A first area having dimensions of 5×7 (654a) and a second area having dimensions of 5×7 (654b) share an edge boundary along the top x-axis (610) with the 11×14 sheet (600). A third area having dimensions of 5×7 (654c) and a fourth area having dimensions of 5×7 (654d) share an edge boundary along the bottom x-axis (630) with the 11×14 sheet (600). The first area having dimensions of 5×7 (654a) and the third area having dimensions of 5×7 (654c) share an edge boundary along the left y-axis (620) with the 11×14 sheet (600). The second area having dimensions of 5×7 (654b) and the fourth area having dimensions of 5×7 (654d) share an edge boundary along the right y-axis (640) with the 11×14 sheet (600). An empty section (660) remains, and may be used for photographs of very small dimensions, in one embodiment, nine photographs of dimensions 1 inch by 1½ inches will fit within the dimensions of the section (660) leaving a small portion unused. Also, in another embodiment, this section (660) may contain information, for example, the photo processor's contact information, multi-layer sheet information, or an advertisement. This empty section (660) may also be left blank.

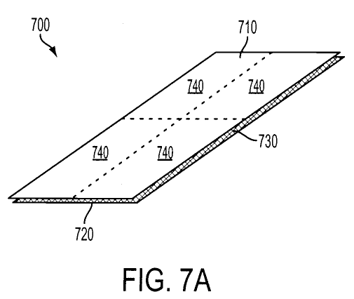

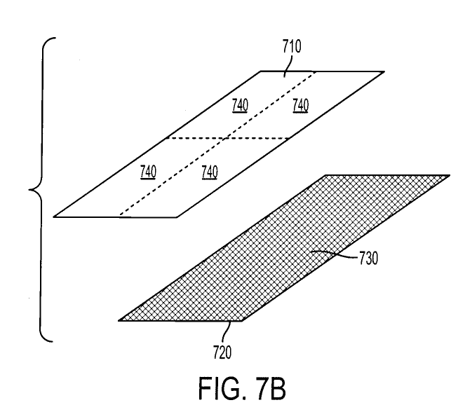

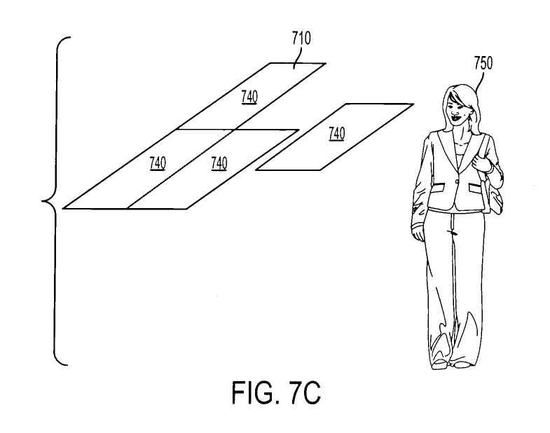

Referring to FIG. 7A, another embodiment is shown. A multi-layered media product (700) for printing in xerographic devices comprises a first sheet (710) and a second sheet (720) of matching dimensions. In one embodiment, the first sheet is a photo quality Xerox® Supreme Gloss sheet, and the second sheet is a Densified Kraft® backer. The first sheet (710) may further be divided into pre-determined dimensions of conventional photograph sizes (740) by scoring, die-perforating, or die-cutting. The second sheet (720) is married to the first sheet (710) with an adhesive (730). In FIG. 7B, the separation of the first sheet (710) from the second sheet (720) is illustrated. In one embodiment, when separated, the first sheet (710) does not retain any of the adhesive (730). The adhesive (730) remains on the second sheet (720) upon the separation of the first sheet (710) from the second sheet (720). In another embodiment, the adhesive (730) remains mostly on the second sheet (720), and the first sheet (710) may still have some adhesive (730) resident upon it. For example, at least half of the adhesive (730) remains upon the second sheet (720). In yet another embodiment, the adhesive (730) allows for the repositioning of the first sheet (710) on the second sheet (720). In FIG. 7C, a disassembling of the first sheet (710) is shown. A recipient (750) of the first sheet (710) may detach all of the conventional photograph sizes (740) from each other. The recipient (750) may also detach one of the conventional photograph sizes (740) at a time, thereby leaving the remainder of the conventional photograph sizes (740) intact with each other.

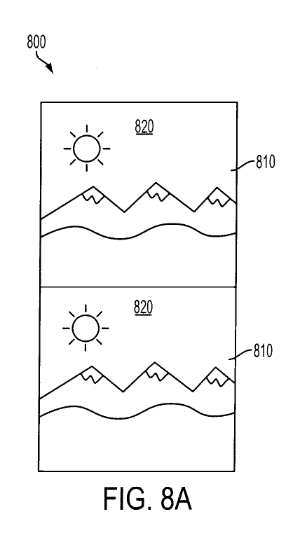

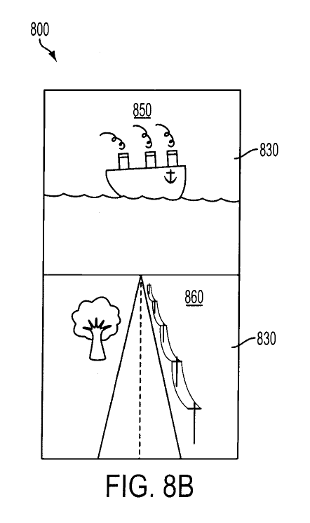

Referring to FIG. 8A, on the first sheet (800), within each pre-determined dimension of a conventional photograph size (810), a photographic image (820) is rendered thereupon. In one embodiment, the same image (820) is rendered upon each pre-determined dimension of a conventional photograph size (810). The pre-determined dimension of a conventional photograph size (810) may differ from another in dimensions, as shown in FIG. 2. In another embodiment, illustrated in FIG. 8B, on the first sheet (800), a first image (850) is rendered upon one particular pre-determined dimension (830), and another image (860) that is different from the first image (850) is rendered upon another particular pre-determined dimension (840).

In each of the embodiments described above, an adhesive is used to marry the first sheet to the second sheet, which as described as the preferred embodiment the first sheet comprises a photo quality Xerox® Supreme Gloss sheet, and the second sheet comprises a Densified Kraft® liner as a backer. In a preferred embodiment, the adhesive is acrylic based, and the adhesive is designed to cleanly release from the photograph face stock, e.g., the Xerox® Supreme Gloss sheet, without adhesive residue. In the preferred embodiment, the adhesive is applied in a thickness of 0.70 mils to the 35# Densified Kraft® liner. The adhesive dries, which causes the adhesive to adhere to the second sheet, which is the 35# Densified Kraft® liner in this embodiment. The adhesive will remain tacky after drying on the surface, which allows for the first sheet, in this embodiment the Xerox® Supreme Gloss sheet, to releasably adhere to the second sheet to form a lamination. The first sheet is then clean edge die-cut into specific photograph sizes. In the preferred embodiment, the amount of force required to separate the die-cut photographs from the second sheet is 17.45 pounds pull as measured by Instron® testing equipment.

It should be understood that any of the features, characteristics, alternatives, or modifications described regarding a particular embodiment herein may also be applied, used, or incorporated with any other embodiment described herein.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

### EXAMPLES

The examples set forth herein below and are illustrative of different physical properties and conditions that can be used in practicing the present embodiments.

Two sheet pilot trails of 3000 11×17 sheets were conducted with subsequent laboratory testing of sheets performance in three different digital printer product lines. These sheets were clean die-cut in a combination of the following pre-determined patterns: one 8×10, one 5×7, and four 2½×3½ photograph sizes. Performance was measured in printer jams per 1000 prints and compared to printer design for shut down rates.

| Digital Printer | Tested Jam Rates |
|---|---|
| Printer # 1 | 3/1000 Prints |
| Printer # 2 | 1/1000 Prints |
| Printer # 3 | 1/1000 Prints |

Other qualitative performance metrics involved were: stacking integrity post fuser, static build in feed drawer, output, toner anchorage, visual appearance of the finished photo compared to silver halide process, and ease of release of the individual photos from the Densified Kraft® liner. Results were acceptable for all qualitative specifications.

Measurements describing the physical properties:

| Facestock Properties | Basis Weight, gsm | TAPPI T410 | |
|---|---|---|---|
| | Brightness, min | TAPPI T411 | 93 +/− 4.5 |
| | % Gloss (Hunter 75 | | 86% |
| | deg) | | |
| Final Composite Properties | | | |
| 1-UP Label | Basis Weight, gsm | TAPPI T410 | 245 ± 10 |
| | Caliper, mils | TAPPI T411 | 10.3 +/− .05 |
| | % Moisture | TAPPI T412 | 4.201 ± 1.0 |
| | Peel Strength | Instron | |
| | Avg Load | | 17.453 ± 5.0% |
| | Max Load | | 43.443 ± 5.0% |
| | Surface Resistivity, | Xerox Method | |
| | ohms/sq | | |
| | Wire | | 7.0 × 10E11(avg) |
| | Smoothness, Hagerty | TAPPI T538 | |
| | Top | | 50 (avg) |
| | Bottom | | 110 (avg) |
| | Taber Stiffness, min | TAPPI T489 | |
| | MD | | 15.675 (avg) |
| | CD | | 9.850 (avg) |
| | MD/CD ratio | | 1.733 (avg) |
| | Die Cut Configuration | Visual | |
| | Label Dimension, L × W | | ±0.41 mm (0.016″) |
| | | | Recommended |
| | Physical Property | XMTC Test Method | Tolerance |
| Cut Sheet Properties | Edge Cut Quality | Xerox PTC via | 5.0 mm max |
| | | microfiche | |
| | Length and Width | | ±0.79 mm (0.031″) |
| | Tolerance | | |
| | Grain of Sheet | | Long Grain [8.5 × 11] |
| | | | Short Grain [17 × 11] |

What is claimed is:

1. A multi-layered sheet suitable for digital printing comprising:
a first sheet patterned in pre-determined dimensions for rendering a photographic image thereupon without utilizing post-processing photo trimming equipment; and
a second sheet married to said first sheet by an adhesive,
wherein said adhesive only remains upon said second sheet when said second sheet is removed from said first sheet.

2. The multi-layered sheet of claim 1, wherein said first sheet lays flat after said second sheet is removed from said first sheet.

3. The multi-layered sheet of claim 1, wherein said first sheet is disassembled along a boundary corresponding with a die-patterned perforation.

4. The multi-layered sheet of claim 1, wherein said first sheet is disassembled along a boundary corresponding with a die-patterned score.

5. The multi-layered sheet of claim 1, wherein said first sheet is optimized for image quality and toner anchorage.

6. The multi-layered sheet of claim 1, wherein said second sheet is of a sufficiently hard surface that is resistant to die patterning damage.

7. The multi-layered sheet of claim 1, wherein said second sheet is optimized for minimal static generation in a sheet feed process.

8. The multi-layered sheet of claim 1, wherein said adhesive is of a thickness of 0.7 mils.

9. A method for providing printed digital photos of conventional dimensions without post-processing photo trimming equipment, the method comprising:
patterning a first sheet in pre-determined dimensions for rendering a photographic image thereupon;
marrying said first sheet to a second sheet with an adhesive,
wherein said adhesive only remains upon said second sheet when said second sheet and said first sheet are separated.

10. The method of claim 9, wherein said first sheet lays flat after said second sheet is removed from said first sheet.

11. The method of claim 9, wherein said first sheet is disassembled along a boundary corresponding with a die-patterned perforation.

12. The method of claim 9, wherein said first sheet is disassembled along a boundary corresponding with a die-patterned score.

13. The method of claim 9, wherein said first sheet is optimized for image quality and toner anchorage.

14. The method of claim 9, wherein said second sheet comprises:
a sufficiently hard surface that is resistant to die patterning damage,
wherein said second sheet is optimized for minimal static generation in a sheet feed process.

15. The method of claim 9, wherein said adhesive is acrylic based.

16. The method of claim 9, wherein said adhesive is of a thickness of at least 0.7 mils.

17. The method of claim 9, wherein said first sheet is patterned into more than one conventional size.

18. A multi-layered sheet suitable for digital printing comprising:
a first sheet patterned in pre-determined dimensions for rendering a photographic image thereupon without utilizing post-processing photo trimming equipment; and
a second sheet married to said first sheet by an adhesive,
wherein said adhesive is acrylic based and allows for repositioning of said first sheet on said second sheet.

19. The multi-layered sheet of claim 18, wherein said adhesive only remains upon said second sheet when said second sheet is removed from said first sheet.

20. The multi-layered sheet of claim 18, wherein said adhesive substantially remains upon said second sheet when said second sheet is removed from said first sheet.
